(19) United States
(12) Patent Application Publication
(10) Pub. No.: US 2012/0218243 A1
(43) Pub. Date: Aug. 30, 2012

(54) POWER SUPPLY SYSTEM AND DISPLAY DEVICE USING THE SAME

(75) Inventors: CHIH-CHAN GER, Jhongli City (TW); TSUNG-LIANG HUNG, Jhongli City (TW)

(73) Assignee: AMPOWER TECHNOLOGY CO., LTD., Jhongli City (TW)

(21) Appl. No.: 13/167,707

(22) Filed: Jun. 24, 2011

(30) Foreign Application Priority Data
Feb. 28, 2011 (CN) 201120049803.8

(51) Int. Cl. G06F 3/038

(52) U.S. Cl. 345/211

(57) ABSTRACT

A power supply system for a display device includes a switch circuit, a transformer and an output filter circuit connected in series, and a controller connected to the switch circuit. The power supply system also comprises a transforming circuit and a superposition circuit. The transforming circuit adjusts amplitude of scanning signals generated by a scanning circuit to generate adjusted scanning signals. The superposition circuit samples high voltage output power signals output by the output filter circuit, superposes the sampled high voltage output power signals and the adjusted scanning signals together to generate a superposition signal, and sends the superposition signal to the controller.

### BACKGROUND

1. Technical Field

The disclosure relates to electronic devices, and particularly to a power supply system and a display device using the same.

2. Description of Related Art

A display device is driven by a power supply system. The power supply system of the display device provides stable power to the display device according to load of the display device. However, the display device generally displays images in a scanning mode, which would lead to a high transient response and subsequently cause the power to be unstable. Correspondingly, the unstable power reduces quality of the images displayed.

### BRIEF DESCRIPTION OF THE DRAWINGS

FIG. 1 is a schematic diagram of one embodiment of a display device as disclosed.

FIG. 2 is a circuit diagram of one embodiment of a transforming circuit and a superposition circuit of a display device as disclosed.

### DETAILED DESCRIPTION

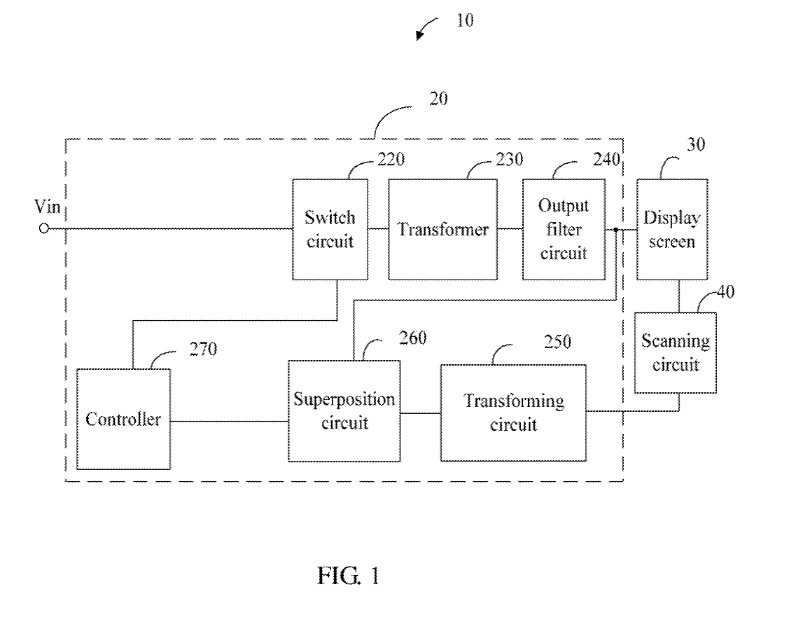

FIG. 1 is a schematic diagram of one embodiment of a display device 10 as disclosed. In the embodiment, the display device 10 comprises a power supply system 20, a display screen 30, and a scanning circuit 40. The power supply system 20 provides power to the display screen 30, such as to drive backlights of the display screen 30. The scanning circuit 40 generates scanning signals to drive the display screen 30 to display images. In the embodiment, the scanning signals are square wave signals. The power supply system 20 comprises a switch circuit 220, a transformer 230, and a filter circuit 240, which are connected in series. In the embodiment, the power supply system 20 also comprises a transforming circuit 250, a superposition circuit 260, and a controller 270.

The switch circuit 220 receives external power signals Vin, and converts the external power signals Vin into first alternating current (AC) power signals, and outputs the first AC power signals to the transformer 230. In one embodiment, the first AC power signals are square wave signals. The transformer 230 converts the first AC power signals into second AC power signals. In one embodiment, the second AC power signals are sine wave signals. The output filter circuit 240 filters the second AC power signals from the transformer 230 into high voltage output power signals suitable to drive the display screen 30. In other embodiment, the power supply system 20 comprises an electromagnetic interference (EMI) filter circuit, an input filter circuit, a switch circuit 220, a transformer 230, and a filter circuit 240, which are connected in series. The EMI filter circuit receives the external power signals Vin, and filters EMI from the external power signals Vin. The input filter circuit is connected to the EMI filter circuit and the switch circuit 220, to filter the external power signals Vin and output direct current (DC) power signals to the switch circuit 220. The switch circuit 220 converts the DC power signals from the input filter circuit into first AC power signals, and outputs the first AC power signals to the transformer 230. The transformer 230 converts the first AC power signals into second AC power signals. The output filter circuit 240 filters the second AC power signals from the transformer 230 into high voltage output power signals suitable to drive the display screen 30.

The transforming circuit 250 is electronically connected to the scanning circuit 40, and adjusts amplitude of the scanning signals output by the scanning circuit 40 to generate adjusted scanning signals. The superposition circuit 260 is connected to the output filter circuit 240 and the transforming circuit 250, to sample the high voltage output power signals output by the output filter circuit 240 and to get the adjusted scanning signals output by the transforming circuit 250. The superposition circuit 260 further superposes the sampled high voltage output power signals and the adjusted scanning signals together to generate a superposition signal, and sends the superposition signal to the controller 270. The controller 270 controls on or off of the switch circuit 220 to output adjusted suitable power signals to drive the display screen 30 according to the superposition signal. Thus, transient response of the high voltage output power signals and quality of images of the display device are improved due to the superposition scanning signal.

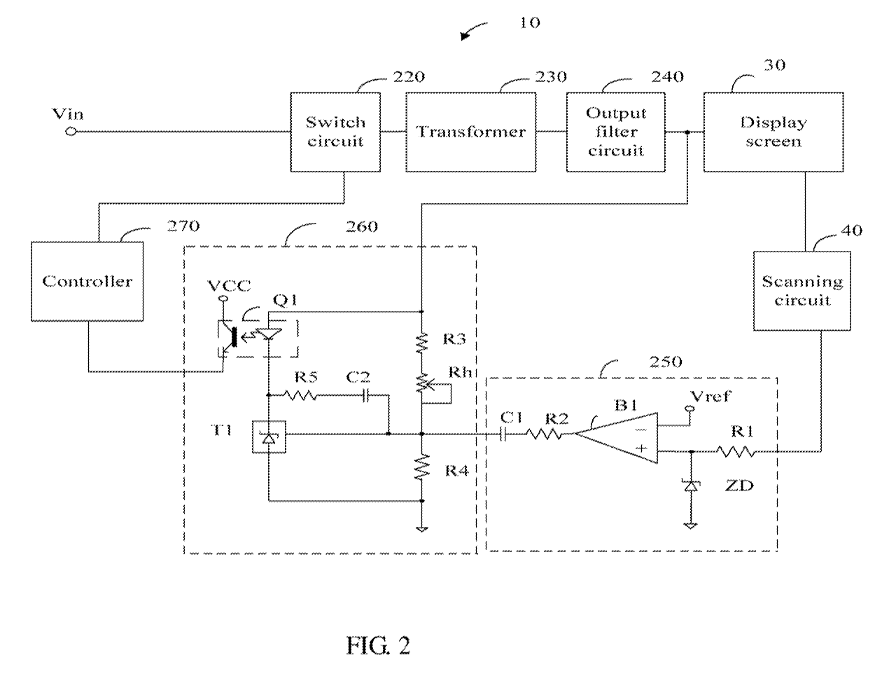

FIG. 2 is a circuit diagram of one embodiment of the transforming circuit 250 and the superposition circuit 260 of the display device 10 as disclosed. In the embodiment, the transforming circuit 250 comprises a first resistor R1, a zener diode ZD, a comparator B1, a second resistor R2, and a first capacitor C1. The superposition circuit 260 comprises a third resistor R3, a variable resistor Rh, a fourth resistor R4, a second capacitor C2, a fifth resistor R5, a microchip T1 and a photocoupler Q1. The first resistor R1 is connected between the scanning circuit 40 and a non-inverting input of the comparator B1. A cathode of the zener diode ZD is connected to the non-inverting input of the comparator B1, and an anode of the zener diode ZD is grounded. An inverting input of the comparator B1 is connected to a first reference power supply Vref. The second resistor R2 is connected between one end of the first capacitor C1 and an output of the comparator B1. The other end of the first capacitor C1 acts as an output of the transforming circuit 250.

The third resistor R3 and the variable resistor Rh are connected in series between the output of the output filter circuit 240 and the output of the transforming circuit 250 in turn. The fourth resistor R4 is connected between the output of the transforming circuit 250 and the ground. The microchip T1 stabilizes voltage, and comprises an anode grounded and a reference pole connected to the output of the transforming circuit 250. The fifth resistor R5 and the second capacitor C2 are connected in series between a cathode of the microchip T1 and the output of the transforming circuit 250 in turn. In the embodiment, the microchip is a TL431 microchip. The photocoupler Q1 comprises a light emitting diode and a transistor. An anode of the light emitting diode is connected to the output of the output filter circuit 240, and a cathode of the light emitting diode is connected to the cathode of the microchip T1. A collector of the transistor is connected to a second reference power supply VCC, and an emitter of the transistor is connected to the controller 270.

In the embodiment, total voltage of the first reference power supply Vref and voltage on the first resistor R1 is set between maximum voltage and minimum voltage of the scanning signals. The scanning signals from the scanning circuit 40 are input to the non-inverting input of the comparator B1 via the first resistor R1. If the voltage of the non-inverting input of the comparator B1 is less than breakdown voltage of the zener diode ZD, the voltage of the non-inverting input of the comparator B1 is compared with the voltage of the inverting input of the comparator B1. If the voltage of the scanning signals is the maximum voltage, the voltage of the non-inverting input of the comparator B1 is greater than the voltage of the first reference power supply Vref. Thus, the comparator B1 generates logic 1, and the transforming circuit 250 outputs logic 1, which is corresponding to the scanning signals with the maximum voltage.

If the voltage of the scanning signals is minimum, the voltage of the non-inverting input of the comparator B1 is less than the voltage of the first reference power supply Vref. The comparator B1 generates logic 0, and the transforming circuit 250 outputs logic 0, which is corresponding to the scanning signals with the minimum voltage. That is, the transforming circuit 250 outputs the adjusted scanning signals with different amplitude from that of the scanning signals. Thus, the adjusted scanning signals are superposed with the sampled high voltage output power signals together to generate the superposition signal to improve the transient response and the quality of the images.

In the embodiment, the zener diode ZD protects the comparator B1 from damage. If the voltage of the non-inverting input of the comparator B1 reaches the breakdown voltage of the zener diode ZD, the zener diode ZD is broken down to make the voltage of non-inverting input of the comparator B1 stable. Thus, the comparator B1 is protected.

The power supply system 20 superposes the sampled high voltage output power signals and the scanning signals with adjusted amplitude together to generate the superposition signal, and sends the superposition signal to the controller 270, which improves the transient response to supply a stable power to the display screen 30. Thus, the quality of the images displayed by the display screen 30 is improved.

The foregoing disclosure of the various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A power supply system of a display device, the power supply system comprising a switch circuit, a transformer, and an output filter circuit connected in series, and a controller connected to the switch circuit, wherein the power supply system also comprising:
a transforming circuit, to adjust amplitude of scanning signals generated by a scanning circuit of the display device to generate adjusted scanning signals; and
a superposition circuit, connected to the output filter circuit and the transforming circuit, to sample high voltage output power signals output by the output filter circuit, superpose the sampled high voltage output power signals and the adjusted scanning signals together to generate a superposition signal, and send the superposition signal to the controller to control the switch circuit.

2. The power supply system of claim 1, wherein the transforming circuit comprises:
a first resistor, one end of the first resistor connected to the scanning circuit of the display device;
a zener diode, wherein an anode of the zener diode is grounded, and a cathode of the zener diode is connected to the other end of the first resistor;
a comparator, wherein an inverting input of the comparator is connected to a first reference power supply, and a non-inverting input of the comparator is connected to the cathode of the zener diode;
a second resistor, connected to an output of the comparator; and
a first capacitor, one end of the first capacitor connected to the output of the comparator via the second resistor and the other end acting as an output of the transforming circuit.

3. The power supply system of claim 2, wherein the superposition circuit comprises:
a third resistor, one end of the third resistor connected to an output of the output filter circuit;
a variable resistor, one end of the variable resistor connected to the other end of the third resistor and the other end of the variable resistor connected to the output of the transforming circuit;
a fourth resistor, connected between the output of the transforming circuit and the ground;
a second capacitor, one end of the second capacitor connected to the output of the transforming circuit;
a fifth resistor, one end of the fifth resistor connected to the other end of the second capacitor;
a microchip, to stabilize voltage of the superposition circuit, wherein an anode of the microchip is grounded, a cathode of the microchip is connected to the other end of the fifth resistor, and a reference pole of the microchip is connected to the output of the transforming circuit; and
a photocoupler, comprising:
a light emitting diode, wherein an anode of the light emitting diode is connected to the output of the output filter circuit and a cathode of the light emitting diode is connected to the cathode of the microchip; and
a transistor, wherein a collector of the transistor is connected to a second reference power supply, and an emitter of the transistor is connected to the controller.

4. A display device, comprising:
a display screen, to display images;
a scanning circuit, to generate scanning signals to drive the display screen to display the images; and
a power supply system of a display device, the power supply system comprising a switch circuit, a transformer, and an output filter circuit connected in series, and a controller connected to the switch circuit, wherein the power supply system also comprising:
a transforming circuit, to adjust amplitude of scanning signals generated by the scanning circuit of the display device to generate adjusted scanning signals; and
a superposition circuit, connected to the output filter circuit and the transforming circuit, to sample high voltage output power signals output by the output filter circuit, superpose the sampled high voltage output power signals and the adjusted scanning signals together to generate a superposition signal, and send the superposition signal to the controller to control the switch circuit.

5. The display device of claim 4, wherein the transforming circuit comprises:
a first resistor, one end of the first resistor connected to the scanning circuit of the display device;
a zener diode, wherein an anode of the zener diode is the ground, and a cathode of the zener diode is connected to the other end of the first resistor;
a comparator, wherein an inverting input of the comparator is connected to a first reference power supply, and a non-inverting input of the comparator is connected to the cathode of the zener diode;
a second resistor, connected to an output of the comparator; and
a first capacitor, one end of the first capacitor connected to the output of the comparator via the second resistor and the other end acting as an output of the transforming circuit.

6. The display device of claim 5, wherein the superposition circuit comprises:
a third resistor, one end of the third resistor connected to an output of the output filter circuit;
a variable resistor, one end of the variable resistor connected to the other end of the third resistor and the other end of the variable resistor connected to the output of the transforming circuit;
a fourth resistor, connected between the output of the transforming circuit and the ground;
a second capacitor, one end of the second capacitor connected to the output of the transforming circuit;
a fifth resistor, one end of the fifth resistor connected to the other end of the second capacitor;
a microchip, to stabilize voltage of the superposition circuit, wherein an anode of the microchip is grounded, a cathode of the microchip is connected to the other end of the fifth resistor, and a reference pole of the microchip is connected to the output of the transforming circuit; and
a photocoupler, comprising:
a light emitting diode, wherein an anode of the light emitting diode is connected to the output of the output filter circuit and a cathode of the light emitting diode is connected to the cathode of the microchip; and
a transistor, wherein a collector of the transistor is connected to a second reference power supply, and an emitter of the transistor is connected to the controller.

7. A display device, comprising a display screen to display images, a power supply system to provide high voltage output power signals to the display screen, and a scanning circuit to provide scanning signals to drive the display screen to display images, wherein the power supply system comprises a transforming circuit to adjust amplitude of the scanning signals provided by the scanning circuit, and a superposition circuit to sample the high voltage output power signals and get the adjusted scanning signals to generate a superposition signal by superposing the sampled high voltage output power signals and the adjusted scanning signals together, and send the superposition signal to a controller to control the provided high voltage output power signals subsequently.

8. The display device of claim 7, wherein the power supply system comprises a switch circuit, a transformer, and a output filter circuit connected in series.

9. The display device of claim 7, wherein the transforming circuit comprises a comparator with an inverting input connected to a first reference power supply, and a non-inverting input receiving the scanning signals via a first resistor.

10. The display device of claim 9, wherein the transforming circuit further comprises a zener diode with an anode being grounded, and a cathode connected to the non-inverting input of the comparator.

11. The display device of claim 10, wherein the transforming circuit further comprises a second resistor connected to an output of the comparator, and a first capacitor with one end connected to the second resistor and the other end outputting the adjusted scanning signals.

12. The display device of claim 7, wherein the superposition circuit comprises a microchip with an anode grounded, a reference pole receiving the adjusted scanning signals, and a cathode connected to the reference pole via a fifth resistor and a second capacitor connected in series.

13. The display device of claim 12, wherein the superposition circuit further comprises a photocoupler comprising a light emitting diode with an anode to sample the high voltage output power signals and a cathode connected to the cathode of the microchip, and a transistor with a collector connected to a second reference power supply and an emitter connected to the controller.

14. The display device of claim 12, wherein the anode of the light emitting diode is connected to the reference pole of the microchip by way of a third resistor and a variable resistor, and the reference pole of the microchip is grounded via a fourth capacitor.
